(19) United States
(12) Patent Application Publication
(10) Pub. No.: US 2025/0155559 A1
(43) Pub. Date: May 15, 2025

(54) Frequency-Modulated Continuous Wave LiDAR Device

(71) Applicant: Ball Photonics, Inc., Portland, OR (US)

(72) Inventors: Paul V. Braun, Portland, OR (US); Peter D. Dragic, Portland, OR (US); Joseph Bernhardt Geddes, III, Portland, OR (US); Lynford Goddard, Portland, OR (US); Boris Kobrin, Portland, OR (US)

(73) Assignee: Ball Photonics, Inc., Portland, OR (US)

(21) Appl. No.: 18/946,734

(22) Filed: Nov. 13, 2024

Related U.S. Application Data
(63) Continuation-in-part of application No. 18/442,735, filed on Feb. 15, 2024.
(60) Provisional application No. 63/548,428, filed on Nov. 14, 2023.

(51) Int. Cl. G01S 7/4911; G01S 7/481

(52) U.S. Cl. CPC G01S 7/4911; G01S 7/4814; G01S 7/4816

(57) ABSTRACT

Methods and systems for determining distance and velocity of one or more objects in a plurality of angular directions using an FMCW LiDAR device are described. Light from a tunable laser source is split and modulated at different frequencies that are assigned to different directions. The modulation circuit transmits swept-wavelength frequency-modulated light, which is split using waveguides with light couplers based on wavelength in some embodiments. The spectral slices are projected using a plurality of apertures onto the ball lens. After a plurality of reflected light signals are reflected by a target, a light detector may collect the reflected light signals. The reflected light signals are mixed with a local oscillator signal and converted to an electrical signal that is sent to a signal processing component. The electrical signal is used to determine the distance and velocity of the target in a plurality of angular directions in parallel.

### RELATED APPLICATIONS

This application is a continuation-in-part of U.S. application Ser. No. 18/442,735, entitled Lidar Device, filed on Feb. 15, 2024, which claims priority to U.S. Provisional Patent Application Ser. No. 63/447,105, entitled Lidar Device, filed on Feb. 21, 2023, and also claims priority to U.S. Provisional Patent Application Ser. No. 63/548,428, entitled FMCW LiDar Device, filed on Nov. 14, 2023 each of which are incorporated by reference along with all other references cited in this application.

### TECHNICAL FIELD

This disclosure relates to methods and devices for light detection and ranging (LiDAR).

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

LiDAR (Light Detection and Ranging) is an active remote sensing method that works on the same principles as radar, but uses light waves sources instead of radio waves. Many experts agree that LiDAR is one of the key sensing technologies to implement partial to full autonomous driving. Besides self-driving cars, or assisted driving, it is also used in robotics and drones, smartphone cameras, and AR headsets. Frequency-Modulated Continuous Wave (FMCW) LiDAR technology is capable, in principle, of measuring reflections from highly diffused surfaces (e.g., a Lambertian surface) located quite far away from the device. Unfortunately, the reliability of detecting objects depends on many factors which are difficult to satisfy simultaneously. Ultimately, the range and visibility offered by a conventional LiDAR solution is determined by the power level and signal-to-noise ratio (SNR) of the system. The SNR decreases with increasing distance, which affects the retrieval accuracy of the LiDAR system. The SNR increases with the laser power, but this parameter has some strong limitations related to eye safety of pedestrians and drivers.

Thus, a new solution is needed to provide LiDAR devices with high SNR ratio, keeping potential exposure of pedestrians and drivers to laser beams below acceptable level.

### SUMMARY

Embodiments according to the present disclosure provide a solution to significantly increase SNR at laser power below acceptable thresholds level for safety. This is achieved by interrogating many targets/directions simultaneously. A tunable laser source is positioned remotely to a ball lens, and the light is transmitted to the ball lens using waveguides with light couplers. A light detector collects reflected light from a target. Distance and velocity of targets may be measured using an FMCW scheme and bin slicing performed by electrical modulation of a signal. Such measurement may be done using electrical spectrum analysis.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a graph showing FMCW LiDAR measurement principles, in an embodiment.

FIG. 2 illustrates a graph showing SNR for the conventional lidar as a function of distance.

FIG. 3 depicts a block diagram illustrating an exemplary system for encoding a modulation frequency onto each beam in a multidirectional LiDAR, in an embodiment.

FIG. 4 illustrates a graph showing frequency bin slicing assignment for different angular directions, in an embodiment.

FIG. 5 depicts a block diagram illustrating an exemplary local oscillator working principle, in an embodiment.

FIG. 6 illustrates a graph showing delay and Doppler frequency shifts, in an embodiment.

FIG. 7 depicts a block diagram illustrating FMCW LiDAR operation, in an embodiment.

FIG. 8 illustrates a graph showing wavelength slicing using arrayed waveguide gratings, in an embodiment.

FIG. 9 depicts a block diagram illustrating splitting of a light beam to N different apertures, in an embodiment.

FIG. 10 illustrates an exemplary FMCW LiDAR device with apertures coupled to a ball lens, in an embodiment.

FIG. 11 illustrates an exemplary light receiving optical path of an FMCW LiDAR device, in an embodiment.

FIG. 12 is an operational flow diagram illustrating a method of determining distance and velocity of a target using an FMCW LiDAR device, in an embodiment.

FIG. 13 depicts a block diagram illustrating a filter bank for separation of N electrical signals, in an embodiment.

FIG. 14 depicts a block diagram illustrating a nonlinear mixer for conversion of signal frequency to a desired range, in an embodiment.

FIG. 15 depicts a block diagram illustrating an exemplary system for accumulating data in a recording device over one frame from N frequency detectors, in an embodiment.

FIG. 16 depicts a block diagram illustrating polarization multiplexing using a polarization switch, in an embodiment.

FIG. 17 illustrates a graph showing SNR calculated for the increased integration time of an FMCW LiDAR device, in an embodiment.

FIG. 18 depicts a signal processing block diagram illustrating FMCW LiDAR device operation, in an embodiment.

FIG. 19 illustrates a block diagram illustrating an exemplary FMCW LiDAR device, in an embodiment.

FIG. 20 depicts an example of the layout of the micro-optical components of an exemplary FMCW LiDAR device.

FIG. 21 depicts an enlarged representation of micro-optical components of an exemplary FMCW LiDAR device.

FIG. 22 depicts a block diagram illustrating an exemplary computing system for execution of the operations comprising various embodiments of the disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the aspects of the disclosure described below are set forth without any loss of generality to, and without imposing limitations upon, the claimed invention.

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “first,” “second,” etc., is used with reference to the orientation of the figure(s) being described. Because components of embodiments of the present invention can be positioned in many different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

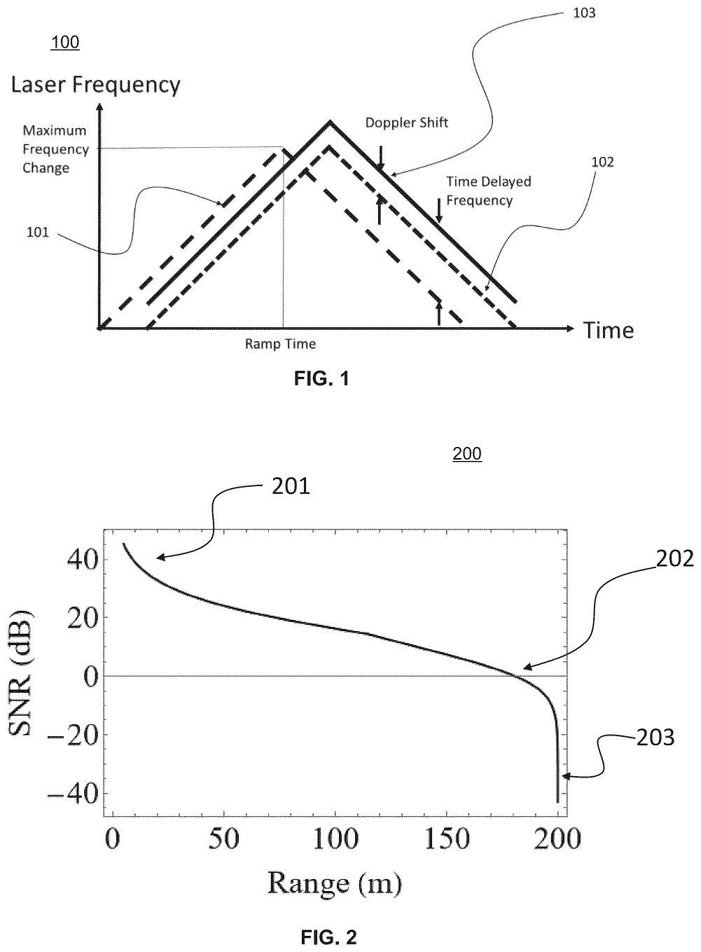

An FMCW LiDAR may include a transmitter, such as a laser, whose optical frequency (i.e., wavelength) is swept or changed in time. The frequency sweep incorporates both an up-ramp and down-ramp to measure both distance and velocity. FIG. 1 illustrates a graph 100 showing FMCW LiDAR measurement principles, in an embodiment. The wavelength sweep of the FMCW LiDAR laser is shown as intermediate dashed line 101. The signal received back from a reflecting target will be a time-shifted version of the transmitted wave (seen in graph 100 as tight dashed line 102). The reflected signal 102 may be used to measure distance from the reflected target using the resulting beat frequency at the receiver. Should the target be moving, a Doppler shift will be imparted, offsetting the frequency of the received signal either up or down depending on the direction of relative motion. The Doppler-shifted reflected signal of a moving target is shown as solid line 103 and may be used to measure the relative velocity of the target.

FMCW LiDARs, using the principles shown in FIG. 1, can provide the user with an image of a distant scene, including distance to and velocity of targets, but are conventionally limited in their field-of-view (FOV). This is a result of the frame rate, typically 25 Hz to 60 Hz, which preferably is set to provide the user with real-time data. Regarding a 25 Hz, or slower frame rate, the time between frames is 1/25 Hz or 40 milliseconds. A typical range for an automotive LiDAR might be 200 meters. The maximum round trip time (or time-of-flight, TOF) in that case is TOF=2*200 m/c where c is the vacuum speed of light, giving TOF=1.333 microseconds. For a single beam LiDAR, or one that samples only in a single direction at a given time, one is then allowed to sample 40 ms/1.333 microseconds ˜30,000 directions per frame. This has at least two key drawbacks. First, if the resolution of the LiDAR is intended to be a typically quoted 0.1° (the angular bin) and each angular bin is adjacent to the next, the maximum FOV becomes approximately 17° by 17°. This is insufficient for a practical automotive LiDAR. To increase the FOV, the angular bins may be spaced further apart, but this leads to gaps in the image, which may resemble strong pixelization or streaks in the image data. Alternatively, the angular bin size may be increased, but this clearly comes at the expense of resolution.

A second drawback to conventional single beam LiDAR systems used for most self-driving cars is the integration time. While each direction is allocated 1.33 microseconds, a measurement begins only after the beam is reflected from the target and returns to the receiver. Therefore, the measurement time, Tₘₑₐₛ, is given by Tₘₑₐₛ=1.33 μs−2D_{target}/c where D_{target} is the distance from the lidar to the target. In the conventional case described above, Tₘₑₐₛ→0 at full range (200 m), and therefore the signal-to-noise ratio (SNR) also falls to 0, and therefore the range of the LiDAR is not truly 200 m. This is illustrated graph 200 in FIG. 2, which details the SNR for the conventional LiDAR as a function of distance for a 20 cm×20 cm Lambertian target with 10% reflectivity, 1 cm diameter receiver aperture, and 20 mW of laser power. The beam is assumed to have a divergence angle of 0.1°. At short ranges (201), the SNR is quite high, and the system has good performance. However, due to the reduction in available integration time, the SNR drops to 1 at a range of about 180 m (202), and at 200 m drops to 0 (203). One way to overcome this problem is to increase the integration time. However, in a conventional LiDAR, this requires decreasing the number of directions, and therefore the FOV will suffer.

Therefore, in some LiDAR configurations, it is desirable to receive a signal from multiple simultaneous different directions. Moreover, it is desirable to receive and process the signals with a single photodetector and analog-to-digital converter rather than multiple photodetectors and analog-to-digital converters so as to not significantly increase the cost or size of the system. By measuring multiple directions in parallel rather than serially, such a configuration enables longer signal integration times for a fixed scene refresh rate and therefore increased signal-to-noise ratio to well beyond the intended operating range. In a preferred embodiment, multiple laser beams are simultaneously transmitted and received by the LiDAR system. These lasers are transmitted in a way that preserves eye safety requirements and standards. However, with a single receiver, there is ambiguity in distinguishing the direction from which a signal came. It is a goal of the present invention to disclose a method for increasing the number of sample points in the far field, filling in the gaps in conventional FMCW LiDARs and enhancing the FOV while at the same time increasing the system SNR.

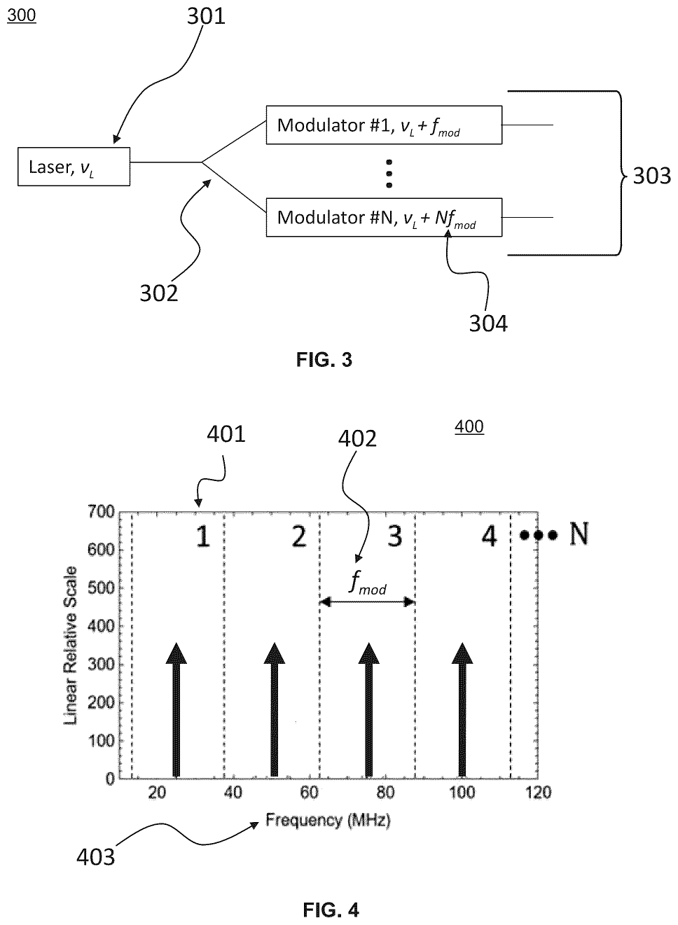

A solution to this problem of distinguishing directions includes encoding a modulation frequency onto each beam in the multidirectional lidar. FIG. 3 depicts a block diagram illustrating an exemplary system 300 for encoding a modulation frequency onto each beam in a multidirectional LiDAR, in an embodiment. A wavelength-swept, single laser signal 301 with optical frequency v_{L}(t) can be split 302 into N different channels using N modulators 303. Each channel n (where N≥n≥1) may pass through its own phase or amplitude modulator 303 operating at a modulation frequency of nf_{mod}, where f_{mod} is a fundamental frequency. For example, the total number of channels N may be 2, 8, 32, or any desired integer value, and the laser power splitting ratio may not be a constant across each channel n. Therefore, the signal or laser frequency 304 of each of the N channels may be offset from each adjacent channel by f_{mod}. The frequency spacing between channels need not be constant, and the frequency of the first channel may be arbitrarily selected and/or may possess an offset or fixed starting value (given any constraints associated with system requirements).

The frequency bin slicing described above may be used to assign a unique frequency channel (i.e., frequency bin) generated by the N modulators 303 to each direction to be measured simultaneously. FIG. 4 illustrates a graph 400 showing frequency bin slicing assignment for different angular directions, in an embodiment. As shown in FIGS. 3 and 4, the laser may be divided into N frequency bins 401 (e.g., using the modulators 303), with each bin having a range of f_{mod} 402. The horizontal axis 403 gives the frequency offset for each different channel generated by the N modulators from each other. In the example figure, f_{mod}=25 MHz, but those of skill in the art would recognize that f_{mod} need not be 25 MHz, and could be any desired frequency range. Indeed, since each channel should be wide enough to be able to measure the large frequency excursions resulting from Doppler shifts, f_{mod} may instead be 50 MHz, 100 MHz, or larger, and does not be in multiples of 5 or 10 or any other number. The frequency channels may be assigned to a direction on a one-to-one basis in some embodiments (e.g. using an aperture assigned to the particular frequency channel), or there may be overlap with different frequency channels being assigned to the same direction in other embodiments, or the same frequency channel being used to send the modulated laser in multiple directions, as discussed below in greater detail.

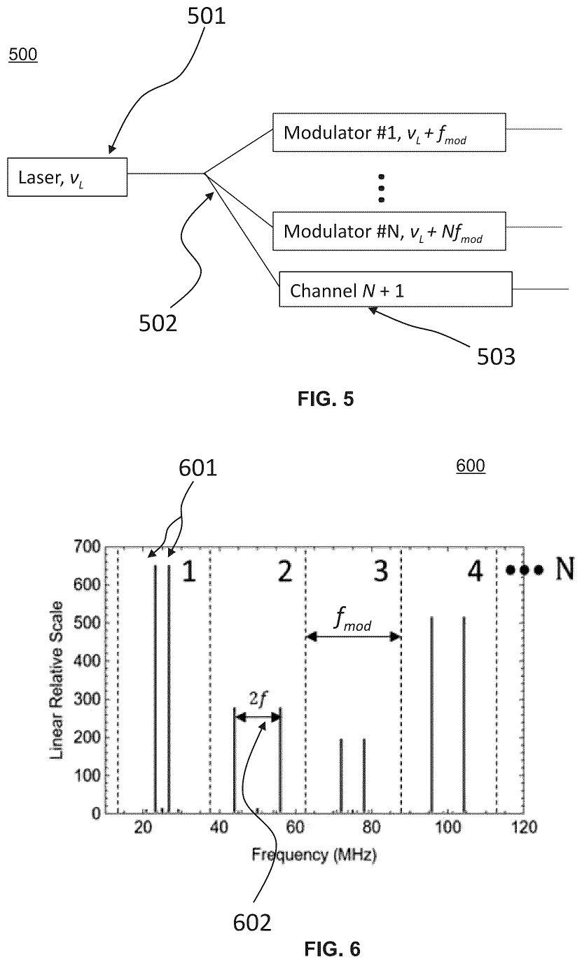

To assist in distinguishing the direction from which a reflected light signal originated, the FMCW LiDAR may utilize a local oscillator (LO) in some embodiments. FIG. 5 depicts a block diagram illustrating an exemplary LO 500 working principle, in an embodiment. The LO signal might be obtained by splitting the laser beam 501 into N+1 channels 502. One of the N+1 channels 503 may serve as the LO, which may or may not itself be frequency modulated. FIG. 6 illustrates a graph of a composite RF spectrum 600 showing delay and Doppler frequency shifts, in an embodiment. When the LO channel 503 is heterodyned with the received laser signal, the output is a pair of sideband signals 601, since the laser is performing a wavelength sweep as shown in FIG. 1. The frequency of each of the sideband signals 601 relative to the center of their assigned frequency bin is f=f Doppler±fdelay, where f_{delay} is the frequency shift due to the distance of the target being measured and f_{Doppler} is the frequency shift due to the velocity of the target. The frequency separation 602 between the sidebands is given by 2*fdelay. The average frequency of the two sidebands 601 is equal to f_{Doppler}. As known to those skilled in the art, both the up ramp and the down ramp shown in FIG. 1 are used to disambiguate f_{Doppler} in terms of an approaching or receding object. For example, if the object is approaching the FMCW LiDAR location, f_{Doppler}>0 and the solid curve 103 is shifted up relative to the tight dashed curve 102. Thus, the beat signal between curves 103 and the local oscillator 101 during the up ramp has a lower frequency than during the down ramp. Conversely, if the object is receding the FMCW LiDAR location, f_{Doppler}<0 and the solid curve 103 is shifted down relative to the tight dashed curve 102, resulting in a higher frequency beat signal during the up ramp compared to the down ramp. Also, as known to those skilled in the art, the amplitude of the return signal will depend, for example, on the target reflectivity and type of surface.

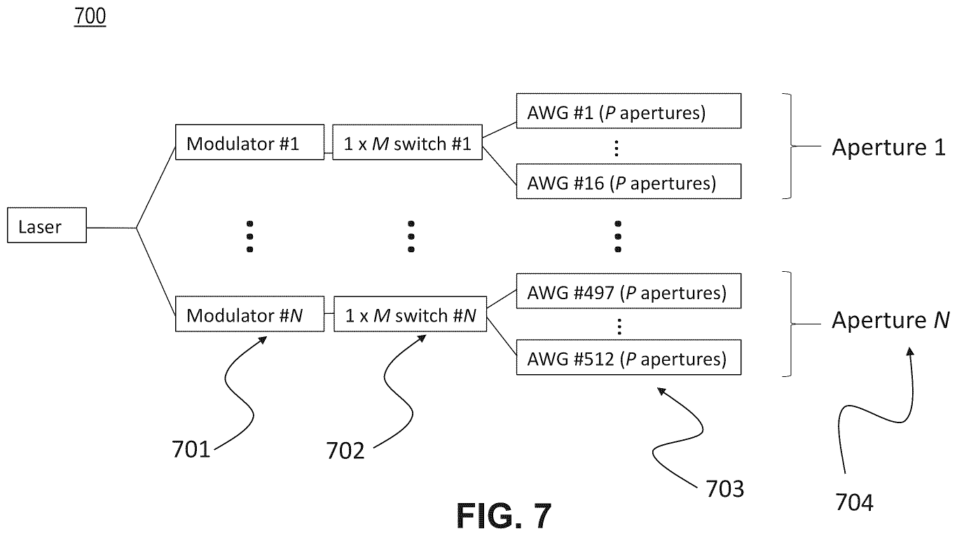

In an exemplary embodiment, the FMCW LiDAR is able to look in N simultaneous directions, increasing the integration time of the FMCW LiDAR device per direction. FIG. 7 depicts a block diagram 700 illustrating such an FMCW LiDAR device operation, in an embodiment. To realize a system that has more total angular bins than a conventional, single beam FMCW LiDAR, each signal 701 from the N modulators may be directed into a corresponding 1×M switch 702. Each switch may subsequently direct the signal 701 into one (or more) of M optical wavelength slicing elements, which in an embodiment are arrayed waveguide gratings (AWGs) 703. The sequence of switch positions may be defined by the user. For example, the positions may be selected in a fixed order and then repeated once the list of positions is complete. Alternatively, the positions may be selected via a simple random sample, with or without replacement, thereby reducing confounding due to time dependent effects. In other embodiments, the positions may be selected via a stratified random sample to reduce confounding to some degree while still maintaining a minimum sampling rate per strata of directions. Also, instead of using AWGs, the wavelength slicing elements may be refractive optical elements such as prisms, reflective optical elements such as blazed gratings or Bragg reflectors, diffractive optical elements such as optical metalenses, or resonant optical elements such as microring resonators instead of the AWGs 703 shown in FIG. 7. Regardless of what wavelength slicing element is used, the total number of wavelength slicing elements may be expressed as the product N×M.

Returning to the AWG embodiment in diagram 700, each AWG in array 703 can be configured to divide the swept, modulated, and switched optical signals into P spectral slices placing each wavelength slice on a unique waveguide. The width of the wavelength slice is given by the AWG wavelength spacing, or the bandpass wavelength range per port of the AWG. Each of the P spectral slices is directed via a waveguide or free space to an emitting aperture, which may correspond to a different direction. For example, the emitting aperture may be formed by a grating coupler at the end of a waveguide. The total number of emitting apertures that can be fed by the transmitter system is therefore the product N×M×P. For example, N may be 32, M might be 16, and P might be 256, giving the total number of apertures that can be fed to be 131,072. In an exemplary simple embodiment, 32 directions may be projected at every unit of time (e.g., one direction per modulator). Since 32 of these directions are projected simultaneously, the total number of temporal slices may be decreased from the conventional, previously described FMCW lidar of 30,000 (25 Hz frame rate) to 131,072/32=4096. Therefore, the maximum integration time may be increased by a factor of 30,000/4096=7.3 times. Further, the total number of directions has been increased by a factor of 131,072/30,000=4.4. It will be recognized by those skilled in the art that N, M, and P may take on values different from those stated above. In particular, the value for N may be increased by using modulators and a photodetector and analog-to-digital converter with increased electrical bandwidth. Likewise, the value for P may be increased by using a wavelength slicing element that has finer spectral slicing.

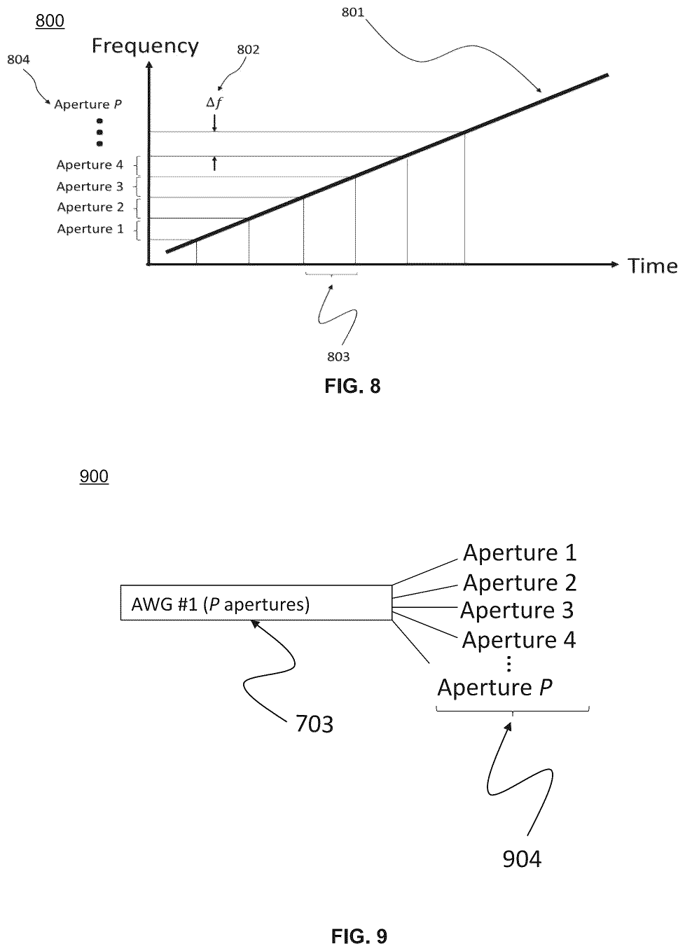

In an exemplary embodiment, banks of AWGs may be used in the FMCW LiDAR device. FIG. 8 illustrates a graph 800 showing wavelength slicing using AWGs, in an embodiment. Graph 800 shows the rising slope 801 of a typical FMCW signal coming through one of the N modulators, its corresponding 1×M switch 702, and arriving at one of the M AWGs 703 per modulator. The AWG serves as a wavelength filter for the system with a bandpass of Δf 802, which corresponds to the frequency selectivity in the frequency domain. Therefore, as the laser signal is periodically swept through the FMCW LiDAR device, each time interval Δtᵢₙₜ 803 of the sweep cycle corresponds to a single Δf spectral slice. Each frequency slice Δf is spatially separated from the other frequency slices, and may be directed to one of P emitting apertures 804 by the AWGs 703. For example, the routing of spectral slices to the emitting apertures may be performed via a waveguide. The total frequency sweep of the laser may be split into P frequency slices which may or may not be equal in width. In general, the width of these optical frequency slices Δf (several tens of GHz) are orders of magnitude greater than the electrical modulation frequency f_{mod} (few GHz) or the frequency shifts f_{delay} and f_{Doppler} (tens of MHz) and thus, no aliasing ambiguity arises between the different apertures when received by a single photodetector.

Therefore, the original laser signal is propagated through N different paths simultaneously to N selected emitting apertures at one instant in time. FIG. 9 depicts a block diagram 900 where the modulated laser signal from one of the modulators 701 is directed into one of the M connected AWGs 703 for that modulator 701 via a switch 702. Depending on the wavelength of the light passing through the switch 702 as the laser wavelength is swept over a predetermined time period, the light signal is directed to one of its P active apertures 904 connected to this AWG 703. In each increment of time within the predetermined time period, this AWG 703 will allow a different wavelength of light to pass through a different aperture of its array of P apertures 904. Therefore, at any one instant in time within the predetermined time period, there are N active apertures over all AWGs 703 emitting light. Light will eventually be emitted from all N×M×P apertures 704 over the predetermined time period.

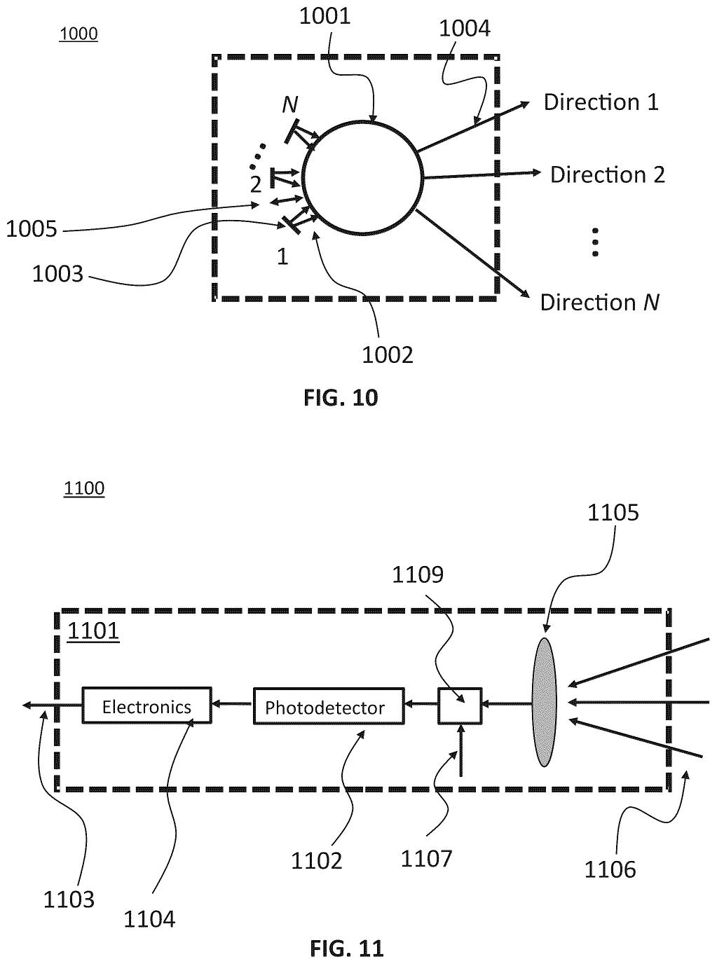

In another embodiment, these emitting apertures are coupled to a lens. FIG. 10 illustrates an exemplary FMCW LiDAR device 1000 with apertures coupled to optical element 1001, in an embodiment. While optical element 1001 is shown as a ball lens, any suitable optical element or combination of elements may be used, including a diffraction grating, a digital light processing projector, etc. The lens 1001 may receive the light rays 1002 emerging from the N apertures 1003 and form beams 1-N 1004 with lower divergence. At a given instance in time, the N apertures 1003 are emitting light rays 1002. The lens 1001 may be a ball lens with diameters in the range of 1 cm to 5 cm or more. The light-emitting apertures 1003 may be grating couplers found at the ends of waveguides, as described above. These grating couplers may be placed at the surface of the lens 1001, or some distance away from the lens 1001, depending on the refractive index of the lens 1001. The distance 1005 between the grating couplers and the lens 1001 can be fine-tuned to control the divergence of the beams 1004 exiting the ball. A preferred target beam divergence may be 0.1° full angle, but this can be a larger or smaller value as desired. The grating couplers may further be configured to conform to the shape of the lens surface, including its curvature. The lens 1001 may also have an optical coating to prevent reflections at the signal wavelength.

FIG. 11 illustrates an exemplary light receiving optical path of an FMCW LiDAR receiver 1101, in an embodiment. The exemplary FMCW LiDAR receiver 1101 utilizes a single photodetector 1102. The receiver 1101 converts the received optical signals 1106 through heterodyning with a local oscillator signal 1107 to an electrical signal 1103. The beam splitter 1109 allows the local oscillator signal 1107 and received optical signals 1106 to be combined on the photodetector 1102. When heterodyning is done (e.g., during the up-ramp portion of FIG. 1) of two signals of optical frequencies v_{L}+nf_{mod}+f_{Doppler}+f_{delay} from the received signal from the nth direction and v_{L} from the local oscillator, several signals at different frequencies will be generated. The generated signals may include two DC signals related to the average powers of the local oscillator and the return signals, two AC signals at double the respective optical frequencies of the oscillator and the return signals, and one AC signal at the sum of these two optical frequencies. However, all three aforementioned AC signals may be filtered out when the photodetector 1102 bandwidth is too slow to detect the THz-rate oscillations of the optical fields. Finally, the heterodyning of the received optical signal 1106 from the nth direction and the local oscillator signal 1107 may also generate one AC signal of interest at a frequency of the difference of the two signals, i.e., nf_{mod}+f_{Doppler}+f_{delay}. During the down-ramp portion of FIG. 1, this one AC signal of interest is at a difference frequency of nf_{mod}+f_{Doppler}−f_{delay}. Thus, considering both the up-ramp and down-ramp portions, we obtain a pair of sideband signals at nf_{mod}+f_{Doppler}±f_{delay} such as 601. When the received signal from more than one direction and the local oscillator are mixed, signals at additional frequencies will be generated; however, the signals from mixing the received signals with each other will be significantly weaker than the signals from mixing the received signals with the local oscillator. Thus, the composite RF spectrum 600, consisting of each pair of sidebands from each direction (i.e. frequency bin) will be the prominent AC signals to reach the electronics 1104. The receiver 1101 may also utilize a balanced detection scheme optimized for heterodyne detection. For example, the photodetector 1102 may be a balanced photodetector that isolates the AC signals from the DC signals. The electrical signal 1103 may be a voltage signal that is amplified to an appropriate level for subsequent electronics. To perform the amplification, additional electronics 1104, which may include transimpedance amplifiers, electrical amplifiers, and/or filters, may be utilized. The receiver 1101 may also have a lens or lens system 1105 that serves to collect the reflected LiDAR return signals 1106 and direct them towards the photodetector 1102. The lens or lens system 1105 may be configured to have a wide FOV. In another embodiment, the transmitting lens is also used as the receiving lens 1105. In some cases, the received signals 1106 may pass back through the same aperture from which they were emitted. In other embodiments, the reflected signals 1106 may pass through a circulator and to their own individual receivers via the apertures.

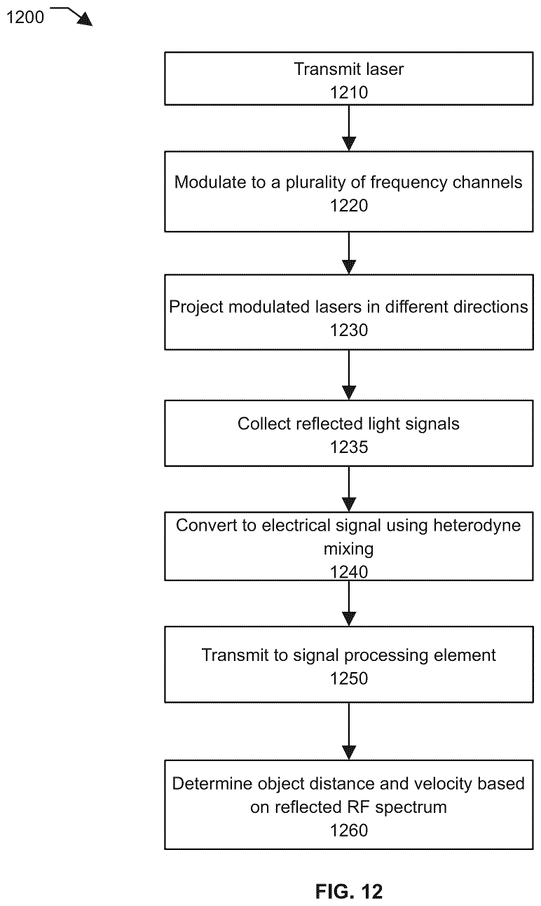

FIG. 12 is an operational flow diagram illustrating a method 1200 of determining distance and velocity of a target using an FMCW LiDAR device, in an embodiment. At step 1210 a tunable laser source positioned remotely to an optical element transmits a laser signal as shown in FIGS. 9 and 10. Using a photonic circuit coupled to the laser source, modulated versions of the transmitted laser may be generated at step 1220, where each modulated version occupies a different frequency channel. At step 1230, a plurality of light directing components coupled to the photonic circuit may project each of the modulated lasers in the plurality of frequency channels in different directions via the optical element. The number of different directions may be increased using a variety of techniques, as discussed below, including polarization switches, time domain switches, and wavelength slicing elements, among others. As detailed herein, the light projected may be spectral, polarization, and/or time domain slices of each of the modulated lasers, depending on how many directions are being queried by the embodiment in question. After a plurality of the projected modulated lasers are reflected by at least one object, a light detector may collect the reflected light signals (e.g., using receiver 1101) at step 1235. At step 1240, the reflected light signals are converted to an electrical signal that includes an RF spectrum using heterodyne mixing, such as signal 1103 shown in FIG. 11.

The electrical signal generated by the FMCW LiDAR receiver may then be used to determine the distance and velocity of the at least one object in a plurality of directions in parallel. For example, at step 1250, the electrical signal may be transmitted to a signal processing element, which determines the distance and velocity of the target in each of a plurality of angular directions in parallel at step 1260. The electrical signal 1103 produced by the receiver 1101 may be analyzed via electronics (the “signal processing component”) to determine relevant values such as a target object's distance from the FMCW LiDAR device and its velocity. The signal processing component may be configured to distinguish between the N different directions that are simultaneously probed by the LiDAR. In one embodiment, the RF input signal (i.e. the sideband signals detected by the photodetector) is simply measured by a single RF spectrum analyzer, which may be included in the electronics. However, the time necessary to measure the entire RF spectrum with sufficient frequency resolution may exceed the measurement time of

$${T}_{meas} = \frac{1}{frame rate} * \frac{1}{M} = \frac{40 ms}{16} = 2.5 ms$$

assuming a 25 Hz frame rate and M=16. There also may be a greater component expense involved with using a single RF spectrum analyzer to cover all of the frequency bins of the signals received. Thus, it is desirable to measure the signals in the N different frequency bins in parallel.

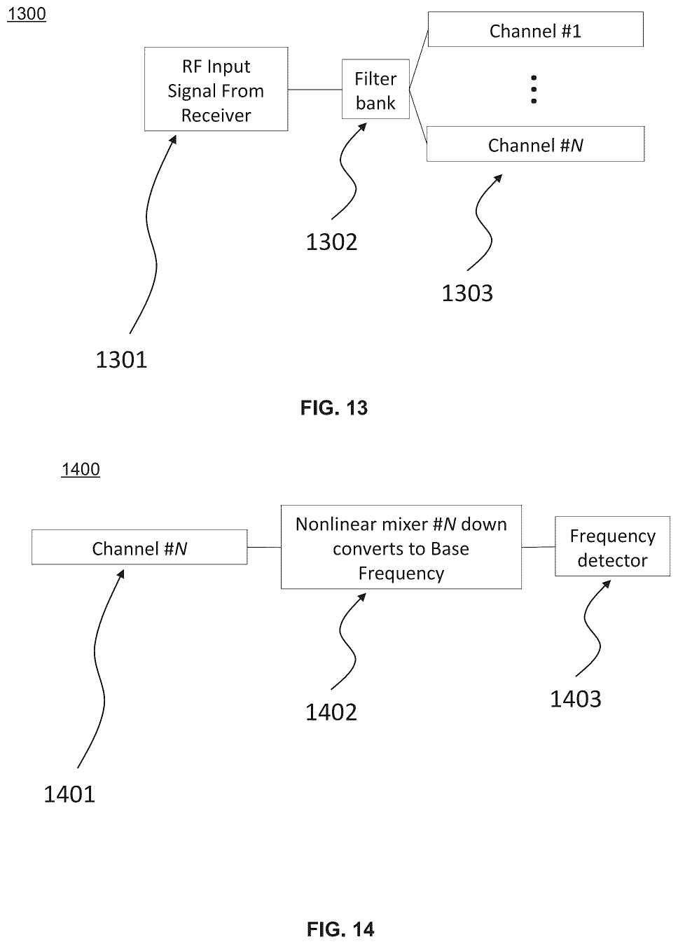

FIG. 13 depicts a block diagram 1300 illustrating a filter bank 1302 for separation of N electrical signals, in an alternative embodiment of the electronics to the RF spectrum analyzer. In one embodiment, the RF signal originating at the receiver 1301 is fed into a filter bank 1302. Filter bank 1302 may separate received RF signal 1301 into the N channels 1303 from each other into N independent electrical signals that can be independently analyzed, preferably in parallel. FIG. 14 depicts a block diagram 1400 illustrating a nonlinear mixer 1402 for conversion of signal frequency to a desired range, in an embodiment. Each subsequent electrically filtered channel 1401 (which may be one of the N channels 1303, for example) may be fed into a nonlinear mixer 1402, which shifts the signal frequency to a desired range (e.g. to facilitate processing using lower frequency and/or less expensive electronics). For example, if the channel spacing is f_{mod}, as in FIG. 6, then the filtered channel n 1401 may have a frequency range

$$[ {f}_{n , Center} - \frac{{f}_{mod}}{2} , {f}_{n , Center} + \frac{{f}_{mod}}{2} ]$$

where f_{n,Center} is the center frequency of filtered channel n. Then, each channel may be converted down from this range to a common range. Preferably this common range extends from

$$[ {f}_{0} - \frac{{f}_{mod}}{2} , {f}_{0} + \frac{{f}_{mod}}{2} ]$$

where f₀ is an arbitrarily chosen center frequency. For example, f₀ may be 60 MHz and f_{mod} may be 100 MHz. The frequency detector 1403 then measures the frequency of the signal in each channel. The frequency detector 1403 may measure the frequencies of the signal sidebands 601 or the average of those sidebands 601 plus a beat frequency produced by the heterodyning of the two sidebands 601.

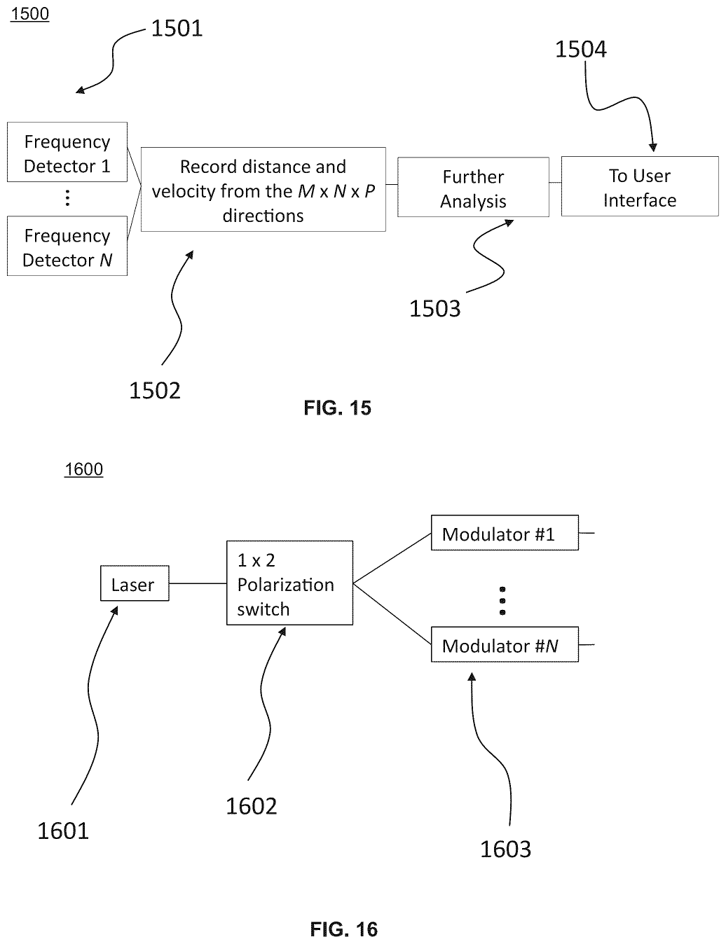

FIG. 15 depicts a block diagram illustrating an exemplary system 1500 for accumulating data in a recording device 1503 over one frame from N frequency detectors, in an embodiment. Recording device 1503 is an example of a signal processing component used to determine the distance and velocity of targets with the FMCW LiDAR device. In the exemplary embodiment, the signals 1501 from the N frequency detectors may be fed into frequency analysis processing components 1502. Each signal 1501 includes {f1, a1} and {f2, a2} frequency and amplitude data for the received sideband signals. Each analysis processing component 1502 averages the frequencies f1 and f2, and then subtracts the center frequency (i.e. the modulation frequency of the channel) to obtain fdoppler for each frequency bin. Each analysis processing component 1502 may also subtract the frequencies f1 and f2 and divide the difference by two to obtain the fdelay for each frequency bin.

Each analysis processing component 1502 may use both fdoppler and fdelay to determine distance and velocity of the object or objects causing the reflected light signals within the frequency bin. The distance and velocity data may be determined based on ramping speed of the laser, and several other known variables. A recording device 1503 that accumulates all distance and velocity data over one frame (i.e. a predetermined time interval) from all the frequency bins to produce a visualization for the frame. The recording device 1503 may output a matrix or list of all distance and velocity information, organized by direction (e.g., latitude and longitude), generated by the analysis processing components 1502. This data is then analyzed by visualization generator 1504, which generates the three-dimensional visualization (e.g., a point-cloud image) from the matrix of distance and velocity data. To assist in generating the visualization, amplitude data of the sideband signals may also be transmitted from each analysis processing component 1502 to the recording device 1503, and then to the visualization generator 1504 to determine reflectivity of the object, in addition to its distance and velocity. The output three-dimensional visualization may then be fed into a user interface 1505.

In some embodiments, it may be desirable to increase the number of directions that can be sampled per emitting aperture. One way to achieve this is to make use of two polarization states, as outlined in FIG. 16. FIG. 16 depicts a block diagram illustrating polarization multiplexing using a polarization switch 1602, in an embodiment. In a first embodiment, the frequency swept laser 1601 encounters a polarization switch 1602 before being fed into the optical modulators 1603. The polarization switch 1602 may switch between the fundamental transverse electric (TE) and transverse magnetic (TM) modes in the waveguide. These would then project in different directions when eventually passing through the emitting aperture. The different directions may result from different phase matching conditions for the TE and TM modes at that aperture, which may be implemented using a grating coupler. In some embodiments, the angular difference between the TE and TM emission angles would be one angular bin. The angular bin range may be set to 0.1° or other desired value. While the polarization switch 1602 is shown as receiving the laser 1601 prior to being transmitted to optical modulators 1603, one skilled in the art would recognize that a polarization switch(es) may be inserted elsewhere in the optical path of the projected light signal.

In another embodiment, each AWG may be configured to pass two wavelengths (or frequencies) to the same aperture per sweep of the laser frequency. For example, the AWG may be configured to have a 50 nm free spectral range (FSR) and the laser may be swept a total of 100 nm. In this case, a signal passes through the same emitting aperture twice per sweep, with two different center wavelengths (center frequencies) at two different moments in time. In the case where more than one signal wavelength passes through the same emitting aperture at different times, each pass through the emitting aperture preferably illuminates a different direction. More preferably, the angular difference between the two different wavelengths emitted from the emitting aperture at different times is one angular bin. The angular bin may be set to 0.1° or other value. It will be clear to those skilled in the art that the AWG may be configured to pass more than two wavelengths at different times per sweep of the laser frequency. The numbers selected herein are meant only for illustrative purposes.

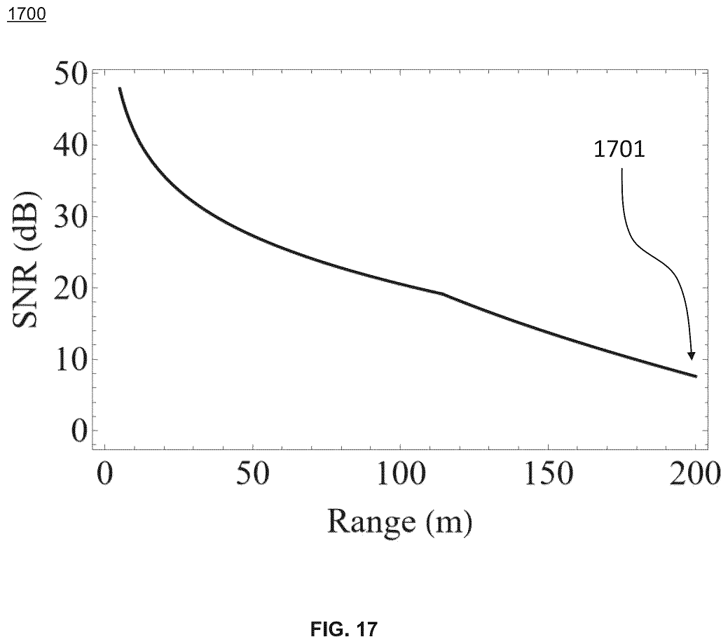

In another embodiment, the FMCW LiDAR may utilize both 2× polarization multiplexing and a configuration that supports each aperture transmitting twice per wavelength sweep of the laser due to the free spectral range (FSR) of each AWG. It will be understood by those skilled in the art that each grating aperture can transmit more than twice per sweep of the laser for an appropriately configured AWG, e.g., if the range of the laser's wavelength sweep is more than twice the FSR of the AWG. As an example, N may be 32, M might be 16, and P might be 256, giving the total number of apertures that can be fed to be 131,072. Two polarizations and two wavelengths together give the total number of directions available to the lidar to be 524,288 directions. Preferably the 4 directions sampled in this case, per emitting aperture, are occupying adjacent but independent angular bins. This results in more than a ten-fold increase relative to the conventional single-beam lidar. In this case, with N=32, there are 524,288/32=16,384 time slices, or advantageously, a value fewer than for the conventional single beam lidar. For a 25 Hz frame rate this gives 1/25 Hz/16,384=2.44 microseconds of integration time per direction. FIG. 17 illustrates a graph 1700 showing SNR calculated for the increased integration time of an FMCW LiDAR device, in an embodiment. Graph 1700 depicts the SNR calculated for the increased integration time for the same system conditions as those used to generate FIG. 2 for a FMCW LiDAR device using both 2× polarization multiplexing and 2× transmitting per wavelength sweep. Due to the increased integration time, the SNR does not drop to zero at a range of 200 m 1701 and is very good over the whole measurement range. Additional directions beyond 524,288 can be achieved, for example, by increasing the number of time domain switches M per modulator, at the expense of a larger footprint due to the increase in the total number of AWGs (N×M) as well as a reduced integration time per direction and thus a reduced SNR.

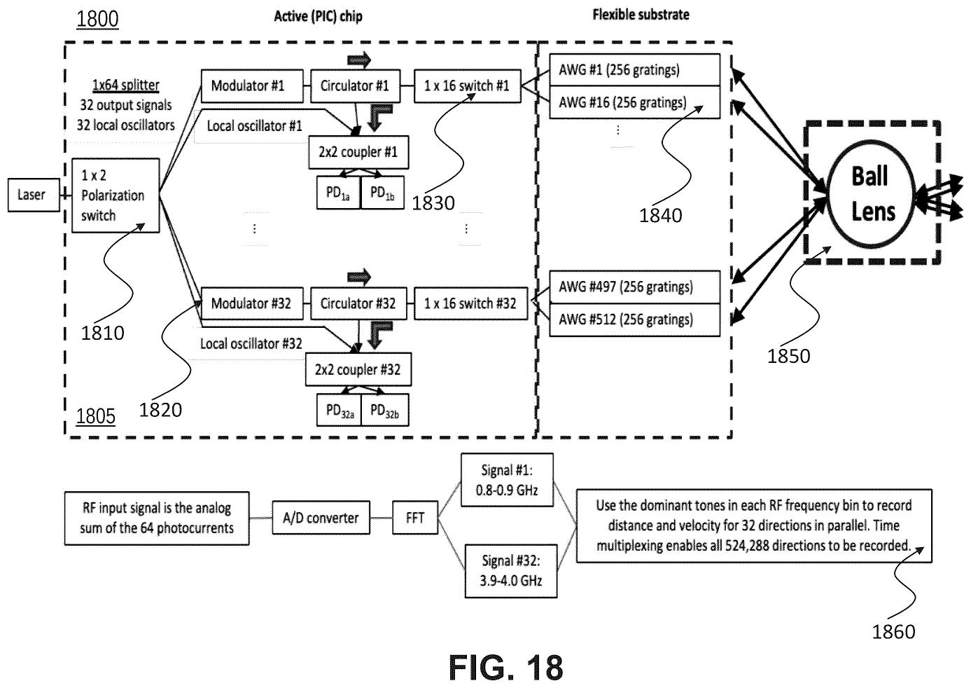

In another embodiment, the signal processing component may be implement as shown in FIG. 18. The signal processing for this specific implementation can be understood as follows:

### Emitting Path:

Polarization multiplexing: The laser is switched between TE and TM polarizations at 50 Hz using polarization switch 1810 of PIC 1805.
Parallel readout: The modulators 1820 encode 32 unique frequencies (RF bins) to allow 32 directions to be read in parallel.
Time multiplexing: Each modulated signal is switched sequentially among its designated set of 16 arrayed waveguide gratings (AWGs) 1840 at 800 Hz using time switches 1830 according to a user defined sequence or a simple or stratified random sample.
Wavelength multiplexing: As the wavelength tunes, each AWG directs light to 1 of 256 different output gratings (131,072 gratings total) 1840. The AWG is designed with a 50 nm FSR. The FMCW wavelength total tuning is 100 nm. The output grating's longitudinal angular dispersion is set to be 0.1 degrees per 50 nm. Thus, each output grating direct light into 2 directions during FMCW wavelength tuning. Further, its latitudinal angular dispersion is set to have a 0.1-degree difference for TE versus TM polarization. Thus, with 131,072 gratings and 4 directions per grating, we achieve 524,288 directions (covers FOV exceeding 160×32 degrees with a resolution of 0.1 degree).

### Receiving Path 1860:

The signal is received through the same ball lens and then is directed with a set of 32 circulators to facilitate mixing with 32 copies of the local oscillators. In the embodiment shown, the photodetection is done with 64 photodiodes. The use of multiple photodetectors is a tradeoff, where the amount of signal is increased at an expense of using up more area on the active PIC chip to host the increased numbers of photodetectors. Each pair of photodetectors may be used to provide a balanced photodetector scheme, where the detected signals of each pair may be subtracted to isolate the desired AC signal at the difference frequency. The photocurrents of these 32 balanced pairs of photodetectors are then summed so that the composite RF signal, such as the one whose RF spectrum is shown in 600, includes information from all interrogated directions and may be measured with a single electrical analysis system 1300. The 4.0 GHz RF spectrum may be divided into 32 bins, each having 100 MHz bandwidth. Frequency of the dominant tone may be determined for each of the 32 bins if it is above the noise floor for that bin. The frequency of the dominant tones may be used to determine the distance and velocity for that individual direction for each of the 32 directions in parallel (while having a better SNR than determining the directions serially).
Overall, a distance and velocity will be measured in 524,288 directions in real time with 25 Hz refresh rate.

A simplified embodiment may include only frequency bin slicing from the N=32 modulators shown in FIG. 18 and can measure 32 directions simultaneously. The number of simultaneous directions can be increased beyond 32 by using a wider RF spectrum by using a more expensive RF system, and/or by using narrower bins at the expense of a lower maximum velocity before bin aliasing occurs due to the Doppler shift. The 1×2 polarization switch, the 1×16 time domain switches, and the wavelength slicing AWGs in FIG. 18 are optional elements that increase the total number of directions. The number of simultaneous directions may remain fixed regardless of whether any of these elements are included. For example, the system can measure a total of 32*2=64 directions when the 1×2 polarization switch is added to the simplified embodiment, 32*16=512 directions when the thirty-two 1×16 time domain switches are added to the simplified embodiment, 32*256=8192 directions when the thirty-two 1×256 AWGs are added, and 32*256*2=16384 directions when the thirty-two 1×256 AWGs are added and the laser is swept across a wavelength range that is double the FSR of the AWGs. As each element may be added independently, systems with a wide variety of total directions may be designed by including some or all these optional elements. In summary, the total number of directions can be: N*M*P*Q*S, where the exemplary embodiment has N=32 simultaneous directions, M=16 time domain switches, P=256 gratings per AWG, Q=2 polarization states, and S=2 as the ratio of the laser wavelength sweep range to the AWG FSR but each of these variables may take on any positive integer value except that Q can only be 1 or 2. The tradeoffs are that more total directions gives better angular resolution, while fewer directions offer greater integration time per direction, and thus better SNR. Fewer directions also require fewer elements and less complicated encoding and decoding schemes and thus offer a smaller footprint and potentially lower cost.

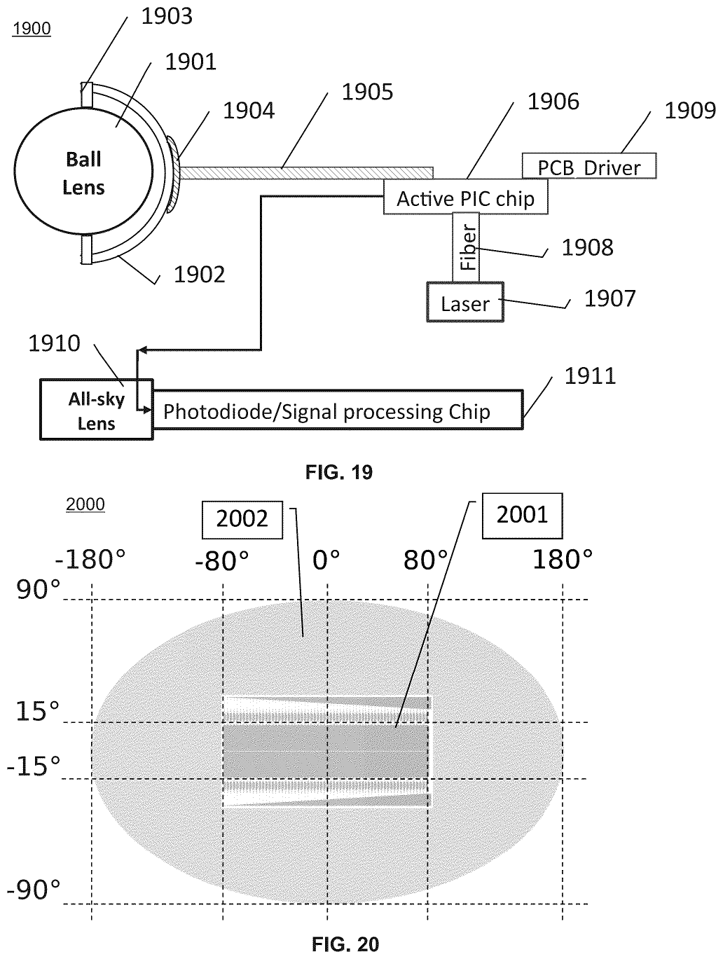

FIG. 19 is a block diagram illustrating an exemplary FMCW LiDAR device 1900, in an embodiment. As shown, the LiDAR 1900 includes a laser 1907 (e.g. a fiber laser, a solid state laser, etc.), which may include a local oscillator as described above, coupled to an optical fiber 1908. After light is projected by the lens 1901, it may be reflected by one or more objects and the reflected light may be received by all-sky lens 1910. Photodiode/signal processing chip 1911 may convert the received light into RF signals, processed as described above to determine distance, velocity, and reflectivity of the one or more detected objects. The optical fiber 1908 may be coupled to one or more photonic integrated circuits (PICs) 1906 containing active and/or passive optical components to receive and modulate the light in time, frequency, polarization state, propagation mode, and so forth as detailed above. In an embodiment, PICs 1906 may perform the steps of modulating the laser 1907 at N different frequencies using PCB driver 1909. PICs 1906 may also include the M time domain switches discussed above used to send the N modulated lasers to M different AWGs located within optical circuit 1904. PCB driver 1909 may also control the M time domain switches within PICs 1906 to achieve the desired modulation.

The FMCW LiDAR 1900 may also include an optical circuit (or optical chip) 1904 (e.g. the AWGs discussed above) that directs light from the PIC(s) 1906 to the emitting apertures, which may be implemented in several different ways. In one embodiment, light is coupled from the one or more PICs 1906, containing the modulators and/or other active and passive photonic components, to the optical circuit by a flexible substrate 1905 containing waveguides or on which waveguides are patterned (e.g., see FIG. 20). Light can also be passed from the PIC(s) 1906 to the optical circuit 1904 via free space coupling, for example by transmitting and receiving grating couplers. Alternatively, light can be passed from the PIC(s) 1906 to the optical circuit 1904 by a fiber bundle. In other embodiments, a combination of those methods can be used.

The optical circuit 1904 used to convey the initial light signal to the lens of the FMCW LiDAR device may be fabricated on a flexible substrate, which allows wrapping of the emitting apertures of the optical circuit 1904 about the lens 1901 coupled to the gratings. The wrapping of the apertures may be at the lens surface or some distance from the lens surface, depending on the lens refractive index. In an embodiment, as the laser wavelength tunes, each AWG of the optical circuit 1904 may transmit the frequency-modulated laser signal to a different diffraction grating aperture connected by waveguides to the AWG output ports. Each grating that receives the laser light can then output the received laser in up to four different directions. The grating itself may be designed to emit light in different directions for the two polarization states and for two wavelengths during the laser wavelength scan, which may be separated by the free spectral range of the AWG. Using more of the directions available to the grating may provide better angular resolution, but using fewer directions may reduce integration time per direction, provide better SNR, occupy less physical space, and require less complicated encoding and decoding hardware and software.

In the embodiment 1900 the ball lens 1901 is supported by a holder 1902 with a standoffs 1903 to suspend the lens at specific distance from the optical circuit 1904, which could be attached to such holder on either inner or outer sides. In one embodiment, the structure of the optical circuit 1904 and/or the waveguide 1905 is fabricated in one or more layers. In some embodiments, the material comprising, underlying, and/or overlying passive components of the optical circuit 1904, such as grating couplers and AWGs, can be engineered to be stiffer than the surrounding materials, which prevents them from being significantly deformed during the fabrication and assembly process, while allowing the overall circuit to be flexible. In embodiments with multilayer circuits, the transmitting apertures (e.g., grating couplers) and other elements are arranged so as not to interfere with each other.

The following is an example of one possible fabrication process flow for a single layer optical circuit 1904.
1. Coat thin fused silica wafer with low index cladding material.
2. Coat high index material for devices and pattern it.
3. Flip wafer onto carrier (e.g., PDMS coated Si or glass).
4. Coat thin fused silica with photoresist and pattern it for etch mask.
5. Etch thin fused silica and strip remaining resist, leaving hard islands underneath sensitive components (e.g., AWG and gratings).
6. Coat structures with PDMS and planarize.
7. Wrap structures around ball. PDMS side touches ball/spacer.

Following is an example of one possible fabrication process flow for a multi-layer optical circuit.
1. Coat thin fused silica wafer with low index cladding material.
2. Coat high index material for devices and pattern it.
3. Coat low index material to encapsulate high index structures and planarize.
4. Repeat prior 2 steps as needed to build up multiple layers.
5. Flip wafer onto carrier (e.g., PDMS coated Si or glass).
6. Coat thin fused silica with photoresist and pattern it for etch mask.
7. Etch thin fused silica and strip remaining resist, leaving hard islands underneath sensitive components (e.g., AWG and gratings).
8. Coat structures with PDMS and planarize.
9. Wrap structures around ball. PDMS side touches ball/spacer.
   Note that there are many possible variations and alternatives on each of these fabrication steps. For example, one could pattern hard islands first, planarize, build up structures on top, coat with PDMS, then release entire stack from wafer with sacrificial layer and wrap around ball lens 1901.

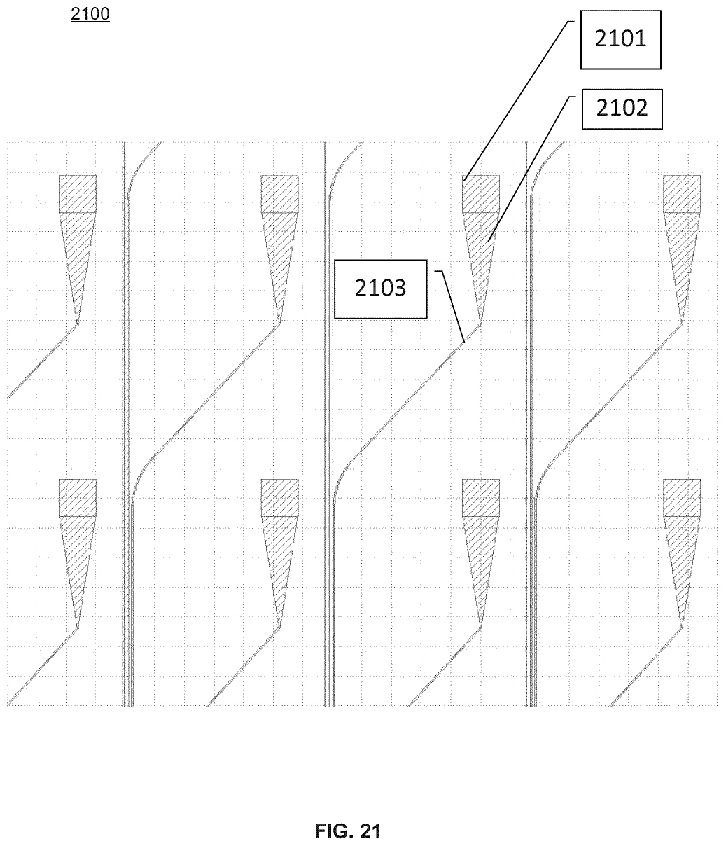

FIG. 20 depicts an example of the layout of the micro-optical components 2000 of an exemplary FMCW LiDAR device, such as optical circuit 1904. The optical circuit 1904 may include waveguides, AWGs, and emitting apertures as described above. These elements 2001 may be arranged over a substantial angular area of the lens 2002 defined by the required Field of View (FOV) to be covered by LiDAR (on the figure corresponding to 160 deg by 30 deg). The waveguides may be arranged to direct light from the PICs to areas of the lens 2002 for output. FIG. 21 depicts an enlarged representation 2100 of micro-optical components of an exemplary FMCW LiDAR device. In one embodiment, the emitting apertures are grating couplers consisting of a grating element 2101 fed by a waveguide 2103. A taper 2102 may increase the efficiency of coupling between the waveguide 2103 and grating element 2101. In other embodiments, the optical circuit may contain other elements to direct light along certain parts of the optical circuit by frequency, polarization state, or optical mode, as described above.

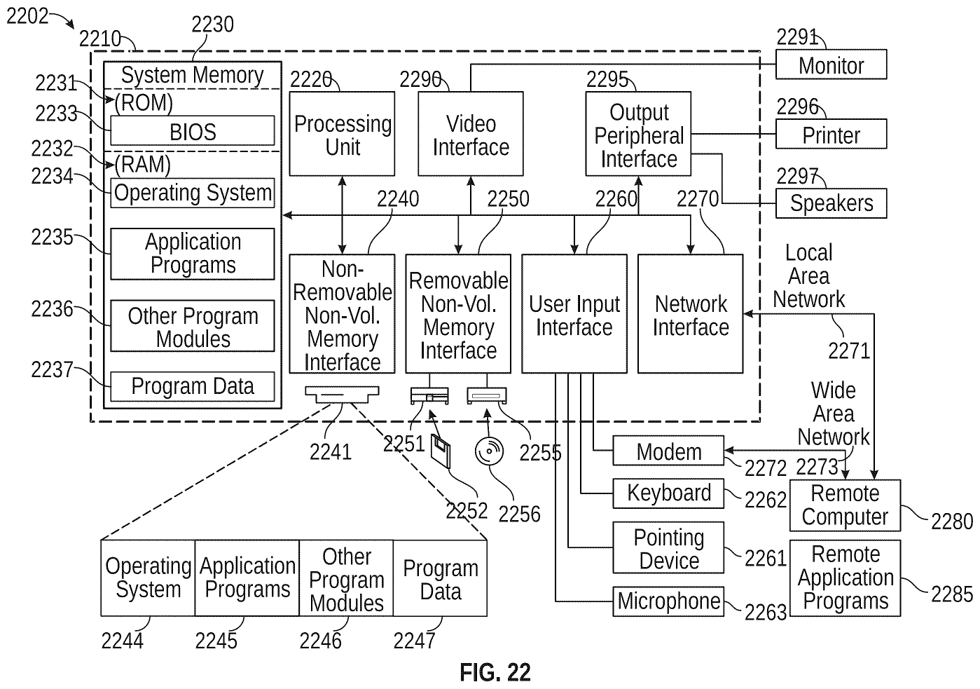

FIG. 22 depicts a block diagram illustrating an exemplary computing system 2200 for execution of the operations comprising various embodiments of the disclosure. The computing system 2202 is only one example of a suitable computing system, such as a mobile computing system, and is not intended to suggest any limitation as to the scope of use or functionality of the design. Neither should the computing system 2202 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 2202 may be implemented as a mobile computing system such as one that is configured to run with an operating system (e.g., iOS) developed by Apple Inc. of Cupertino, California or an operating system (e.g., Android) that is developed by Google Inc. of Mountain View, California.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

The computing system 2202 may include, but are not limited to, a processing unit 2220 having one or more processing cores, a system memory 2230, and a system bus 2221 that couples various system components including the system memory 2230 to the processing unit 2220. The system bus 2221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 2202 typically includes a variety of computer readable media. Computer readable media can be any available media that can be accessed by computing system 2202 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 2202. Communication media typically embodies computer readable instructions, data structures, or program modules.

The system memory 2230 may include computer storage media in the form of volatile and/or nonvolatile memory such as read only memory (ROM) 2231 and random access memory (RAM) 2232. A basic input/output system (BIOS) 2233, containing the basic routines that help to transfer information between elements within computing system 2202, such as during start-up, is typically stored in ROM 2231. RAM 2232 typically contains data and/or program modules that are immediately accessible to and/or presently being operated on by processing unit 2220. By way of example, and not limitation, FIG. 22 also illustrates operating system 2234, application programs 2235, other program modules 2236, and program data 2237.

The computing system 2202 may also include other removable/non-removable volatile/nonvolatile computer storage media. By way of example only, computing system 2202 also illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 2241 is typically connected to the system bus 2221 through a non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in computing system 2202, provide storage of computer readable instructions, data structures, program modules and other data for the computing system 2202. In FIG. 22, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. The operating system 2244, the application programs 2245, the other program modules 2246, and the program data 2247 are given different numeric identification here to illustrate that, at a minimum, they are different copies.

A user may enter commands and information into the computing system 2202 through input devices such as a keyboard 2262, a microphone 2263, and a pointing device 2261, such as a mouse, trackball or touchpad or touch screen. Other input devices (not shown) may include a joystick, gamepad, scanner, or the like. These and other input devices are often connected to the processing unit 2220 through a user input interface 2260 that is coupled with the system bus 2221 but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2290.

The computing system 2202 may operate in a networked environment using logical connections to one or more remote computers, such as a remote computer 2280. The remote computer 2280 may be a personal computer, a hand-held device, a server, a router, a network PC, a peer device or other common network node, and typically includes many or all of the elements described above relative to the computing system 2202. The logical connections depicted in computing system 2202 include a local area network (LAN) 2271 and a wide area network (WAN) 2273 but may also include other networks. Such networking environments are commonplace in offices, enterprise-wide computer networks, intranets and the Internet.

When used in a LAN networking environment, the computing system 2202 may be connected to the LAN 2271 through a network interface or adapter 2270. When used in a WAN networking environment, the computing system 2202 typically includes a modem 2272 or other means for establishing communications over the WAN 2273, such as the Internet. The modem 2272, which may be internal or external, may be connected to the system bus 2221 via the user-input interface 2260, or other appropriate mechanism. In a networked environment, program modules depicted relative to the computing system 2202, or portions thereof, may be stored in a remote memory storage device. By way of example, and not limitation, FIG. 22 illustrates remote application programs 2285 as residing on remote computer 2280. It will be appreciated that the network connections shown are exemplary and other means of establishing a communications link between the computers may be used.

It should be noted that some embodiments of the present invention may be carried out on a computing system such as that described with respect to computing system 2202. However, some embodiments of the present invention may be carried out on a server, a computer devoted to message handling, handheld devices, or on a distributed system in which different portions of the present design may be carried out on different parts of the distributed computing system.

Another device that may be coupled with the system bus 2221 is a power supply such as a battery or a Direct Current (DC) power supply) and Alternating Current (AC) adapter circuit. The DC power supply may be a battery, a fuel cell, or similar DC power source that needs to be recharged on a periodic basis. The communication module (or modem) 2272 may employ a Wireless Application Protocol (WAP) to establish a wireless communication channel. The communication module 2272 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A frequency-modulated continuous wave light detection and ranging (FMCW LiDAR) system comprising:
a tunable laser source positioned remotely to an optical element, the laser source transmitting a laser signal;
a photonic circuit coupled to the laser source that modulates the laser signal to a plurality of frequency channels;
a plurality of light directing components coupled to the photonic circuit, the light directed components projecting each of the modulated laser signals in the plurality of frequency channels in different directions via the optical element;
a light detector that collects a plurality of reflected light signals reflected by at least one object and performs heterodyne mixing with a local oscillator laser signal to create a composite RF spectrum; and
a signal processing component that uses frequency bin slicing on the composite RF spectrum to determine the distance and velocity of the at least one object in each of a plurality of angular directions in parallel.

2. The system of claim 1, the plurality of light directing components projecting each of the modulated laser signals in the plurality of frequency channels in different directions by:
splitting, using wavelength slicing elements, each of the modulated laser signals in the plurality of frequency channels into spectral slices that include wavelengths of the modulated laser signals of the frequency channel at a particular moment in time, the splitting resulting in a set of spectral slices over a predetermined period of time associated with a period of the modulated laser of the frequency channel;
assigning each spectral slice to a different angular direction;
projecting the spectral slices to the optical element; and
sequentially varying a set of all angular directions being measured over the predetermined period of time.

3. The system of claim 2, the projecting each of the modulated laser signals in the plurality of frequency channels in different directions further comprising sweeping, for each wavelength slicing element, a laser wavelength across a wavelength range that is double a free spectral range of the wavelength slicing element, thereby doubling the number of angular directions that light is projected.

4. The system of claim 1 where the light directing components are waveguides with light couplers.

5. The system of claim 4 in which the waveguides are arrayed waveguide gratings.

6. The system of claim 4 where the waveguides each direct light at more than one different wavelength to an emitting aperture that directs the modulated laser for the corresponding frequency channel to a plurality of angularly resolved directions.

7. The system of claim 6 where the emitting aperture is a grating coupler.

8. The system of claim 1 in which a doppler frequency and a delay frequency associated with the reflected light signals are used to determine the velocity and distance of the object.

9. The system of claim 1 where the optical element is a ball lens.

10. The system of claim 1 where one or more photodetectors are used to receive the plurality of reflected light signals.

11. The system of claim 10 in which one or more of the photodetectors is a balanced photodetector.

12. The system of claim 11 in which the one or more balanced photodetectors sums a plurality of photocurrents to create a signal containing object information from more than one of the plurality of angular directions.

13. The system of claim 1 where electrical spectral analysis is used by the signal processing component to disambiguate the signals from different angular directions.

14. The system of claim 1, where a time domain switch is used to sequentially vary the set of angular directions being measured prior to projecting the modulated laser signals to the optical element.

15. The system of claim 1 in which a polarization switching device is used to sequentially vary the set of angular directions being measured prior to projecting the modulated laser signals to the optical element.

16. The system of claim 1 in which the modulated laser signals are directed to more than one emitting aperture.

17. The system of claim 16 in which the one or more emitting apertures are located on the surface of a ball lens.

18. The system of claim 16 in which the one or more emitting apertures are located on the surface of a spacer positioned at a distance from the ball lens using standoffs.

19. The system of claim 16 in which the one or more emitting apertures and one or more arrayed waveguide gratings are fabricated on a flexible substrate.

20. The system of claim 19 in which a flexible substrate is wrapped around a ball lens at the lens surface or at some distance from the lens surface.
